(19) United States
(12) Patent Application Publication
(10) Pub. No.: US 2017/0114717 A1
(43) Pub. Date: Apr. 27, 2017

(54) AXIAL STAGE COMBUSTION SYSTEM WITH EXHAUST GAS RECIRCULATION

(71) Applicant: Siemens Energy, Inc., Orlando, FL (US)

(72) Inventors: Scott M. Martin, Daytona Beach, FL (US); Walter Ray Laster, Oviedo, FL (US); Juan Enrique Portillo Bilbao, Oviedo, FL (US)

(21) Appl. No.: 15/311,856

(22) PCT Filed: Jun. 26, 2014
(86) PCT No.: PCT/US2014/044241

§ 371 Date: Nov. 17, 2016

(51) Int. Cl. F02C 3/34; F02C 3/14; F02C 7/22; F01K 23/10

(52) U.S. Cl. CPC F02C 3/34; F01K 23/10; F02C 3/14; F02C 7/22; F05D 2220/60; F05D 2240/35; F05D 2220/76

(57) ABSTRACT

A method of operating an axial stage combustion system in a gas turbine engine (12) including an EGR system (14) that extracts a portion of exhaust gas produced by the gas turbine engine (12) to a second axial stage of a combustor (18). The extracted exhaust gas is provided at an elevated temperature to a group of injector nozzles (50) at the second axial stage (34) of the combustor (18). A secondary fuel supply line (34) extends to an inlet on each of the injector nozzles (50), and the fuel is mixed with the exhaust gas within the injector nozzles (50) and the mixture of fuel and exhaust gas is injected into the second axial stage (34) of the combustor (18).

### STATEMENT REGARDING FEDERALLY SPONSORED DEVELOPMENT

Development for this invention was supported in part by Contract No. DE-FC26-05NT42644, awarded by the United States Department of Energy.

Accordingly, the United States Government may have certain rights in this invention.

### TECHNICAL FIELD

The present invention relates to gas turbine engines and, more particularly, to a gas turbine engine with exhaust gas recirculation to control emissions in an axial stage combustion system.

### BACKGROUND ART

Gas turbines, such as may be used in simple or combined cycle power plants, combust a mixture of fuel and compressed air to produce a hot working gas. The working gas expands through stages of a turbine to produce power that can be used to drive a load, i.e., a generator, and/or to drive a compressor. The gas exhausted from the turbine can include various combustion by-products, such as carbon monoxide (CO), nitrous oxide (NOx) and its derivatives, and carbon dioxide (CO₂). These by-products, or emissions, are generally subject to regulations which are typically increasingly stringent, and which can often impose operational constraints that result in decreases or limitations on power output and efficiency.

For example, increases in turbine inlet temperature (TIT) that can increase efficiency may also increase the level of NOx, unless additional measures are implemented to counteract the increased emissions associated with higher temperatures. Such additional measures have included injection of diluents to decrease the flame temperature, such as diluents comprising CO₂, N₂ and/or steam. However, although these diluents have been effective at reducing emissions, they typically add to the plant cost, and some diluents may not be readily available for use at all plants.

### SUMMARY OF INVENTION

In accordance with an aspect of the invention, a method of operating an axial stage combustion system in a gas turbine engine is provided, the axial stage combustion system having an axial stage combustor supplying hot working gases to a turbine. The method includes providing a fuel supply line supplying a fuel to the combustor; supplying compressed air to a head end of a combustor and mixing the compressed air with the fuel; igniting the fuel and compressed air in a first axial stage of the combustor to form a hot working gas supplied to the turbine; and providing an exhaust gas recirculation (EGR) system extracting a portion of exhaust gas produced by the gas turbine engine to a second axial stage of the combustor. The operation of the EGR system includes conveying a mass flow of exhaust gas extracted from the gas turbine engine to a group of injector nozzles at the second axial stage of the combustor; conveying a flow of fuel through a secondary fuel supply line to each of the injector nozzles, wherein the secondary fuel supply line extends to an inlet on each of the injector nozzles to isolate the fuel from the exhaust gas; and mixing the fuel with the exhaust gas within the injector nozzles and injecting the mixture of fuel and exhaust gas into the second axial stage of the combustor.

The fuel and exhaust gas may be exclusive constituents of the mixture formed in the injector nozzle.

The exhaust gas may be partially cooled to a temperature below an auto-ignition temperature for the fuel as the exhaust gas is conveyed from the gas turbine engine to the injector nozzles. Subsequent to the partial cooling, the pressure of the exhaust gas may be increased to a pressure above a shell air pressure in the combustor while maintaining the temperature of the exhaust gas below the auto-ignition temperature for the fuel.

The temperature of the exhaust gas provided to the second axial stage of the combustor may be up to 200° C. greater than the temperature of gases provided to the head end of the combustor.

The injector nozzles may comprise a plurality of circumferentially spaced nozzles extending through a wall of the combustor defining a flow boundary in contact with the hot gases passing through the combustor.

The entire mass flow of exhaust gas extracted from the gas turbine engine for the EGR system may be conveyed to the second axial stage.

The mass flow of exhaust gas extracted from the gas turbine engine may be between 8% and 15% of the total mass flow of exhaust gas exiting the turbine.

The exhaust gas can be conveyed through a heat recovery steam generator (HRSG) prior to the exhaust gas entering the second axial stage of the combustor, wherein the HRSG can be the sole heat extraction component in a flow path for the exhaust gas from the gas turbine engine to the second axial stage of the combustor.

Subsequent to passing through the HRSG, the pressure of the exhaust gas may be increased to a pressure above a shell air pressure in the combustor while maintaining the temperature of the exhaust gas below an auto-ignition temperature for the fuel.

In accordance with another aspect of the invention, a method of operating an axial stage combustion system in a gas turbine engine is provided, the axial stage combustion system having an axial stage combustor supplying hot working gases to a turbine. The method includes providing a fuel supply line supplying a fuel to the combustor; supplying compressed air to a head end of a combustor and mixing the compressed air with the fuel; igniting the fuel and compressed air in a first axial stage of the combustor to form a hot working gas supplied to the turbine; providing an exhaust gas recirculation (EGR) system extracting a portion of exhaust gas produced by the gas turbine engine to a second axial stage of the combustor. The operation of the EGR system includes conveying a mass flow of exhaust gas extracted from the gas turbine engine to the second axial stage of the combustor; conveying a flow of fuel through a secondary fuel supply line to the second axial stage of the combustor; mixing the fuel with the exhaust gas to provide a mixture of fuel and exhaust gas into the second axial stage of the combustor; and conveying the exhaust gas through a heat recovery steam generator (HRSG) prior to the exhaust gas entering the second axial stage of the combustor, wherein the HRSG is the sole heat extraction component in a flow path for the exhaust gas from the gas turbine engine to the second axial stage of the combustor.

The exhaust gas can be cooled in the HRSG to a temperature below an auto-ignition temperature for the fuel.

Subsequent to passing through the HRSG, the pressure of the exhaust gas may be increased to a pressure above a shell air pressure in the combustor while maintaining the temperature of the exhaust gas below an auto-ignition temperature for the fuel.

The temperature of the exhaust gas provided to the second axial stage of the combustor may be up to 200° C. greater than the temperature of gases provided to the head end of the combustor.

The fuel and exhaust gas may be provided to a plurality of circumferentially spaced nozzles extending through a wall of the combustor defining a flow boundary in contact with the hot gases passing through the combustor.

The entire mass flow of exhaust gas extracted from the gas turbine engine for the EGR system may be conveyed to the second axial stage and may be between 8% and 15% of the total mass flow of exhaust gas exiting the turbine.

In accordance with a further aspect of the invention, a power plant is provided comprising a gas turbine engine having an axial stage combustor supplying hot working gases to a turbine, a fuel supply supplying a fuel through a first supply line to the combustor, and the gas turbine engine having a compressor supplying compressed air to a head end of the combustor. The combustor has a first axial stage where a mixture of the fuel and compressed air are ignited to form the hot working gas supplied to the turbine. An exhaust gas recirculation (EGR) system is provided having an inlet extracting a portion of exhaust gas produced by the gas turbine engine and an outlet providing exhaust gas as a diluent to a second axial stage of the combustor. The EGR system includes an exhaust flow line conveying exhaust gas to the second axial stage of the combustor, a secondary fuel supply line conveying fuel from the fuel supply to the second axial stage of the combustor, and a group of circumferentially spaced injector nozzles at the second axial stage of the combustor. Each of the injector nozzles has a pair of inlets including a separate inlet for receiving a flow of exhaust gas from the exhaust flow line and a separate inlet for receiving a flow of fuel from the secondary fuel flow line, and each injector nozzle mixes the exhaust gas with the fuel and injects the mixture of exhaust gas and fuel into the second axial stage of the combustor.

The entire portion of exhaust gas extracted from the gas turbine engine for the EGR system may be conveyed to the second axial stage and may be between 8% and 15% of the total mass flow of exhaust gas exiting the turbine.

A heat recovery steam generator (HRSG) may be located in the exhaust flow line between the inlet and the outlet of the EGR system, wherein the HRSG may be the sole heat extraction component in the exhaust flow path from the gas turbine engine to the second axial stage of the combustor.

### BRIEF DESCRIPTION OF DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a schematic diagram of a portion of a simple cycle power plant illustrating aspects of the present invention;

FIG. 2 is a schematic diagram of a portion of a combined cycle power plant illustrating aspects of the present invention;

FIG. 3 is a cross-sectional view of an axially staged combustor in accordance with aspects of the present invention; and

FIG. 4 is a cross-sectional view of a nozzle for an axial stage of the combustor of FIG. 3.

### DESCRIPTION OF EMBODIMENTS

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

The present invention is directed to use of exhaust gas in a gas turbine engine, using recirculated exhaust gas with stoichiometric combustion to decrease formation of NOx emissions. In order to operate a gas turbine engine at higher turbine inlet temperatures (TIT's) without a significant increase in NOx or acoustics, an axially staged combustor can be implemented. In accordance with an aspect of the invention, it has been noted that injecting pure fuel into an axial stage of the combustor can result in very high local flame temperatures, which can include an associated increase in NOx. In accordance with a further aspect of the invention, a relatively small percentage of exhaust gas produced by the gas turbine engine can be recirculated to an axial stage of the combustor for the engine as a diluent to reduce NOx emissions in combustion products formed at elevated flame temperatures, e.g., up to about 1700° C. In accordance with a further aspect of the invention, minimal cooling is applied to the recirculated exhaust gas resulting in reduced cooling costs, and the exhaust gas can be conveyed separately from a secondary fuel supply to the axial stage of the combustor. In accordance with an additional aspect of the invention, the exhaust gas is provided to an injection nozzle at the axial stage of the combustor and is mixed with a secondary fuel at the injection nozzle as it is injected into the combustor.

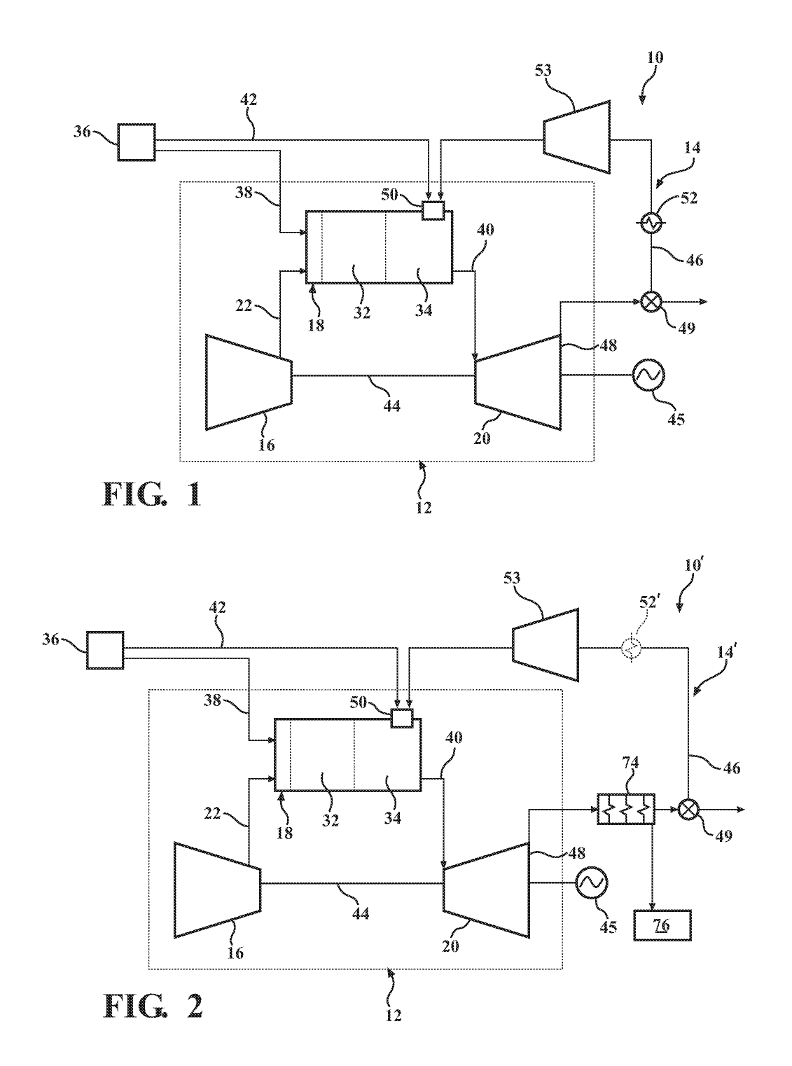

Referring to FIG. 1, a power plant 10 is illustrated. The power plant 10 includes a gas turbine engine 12 to generate power and/or electricity from the production of a high temperature working gas during combustion. The gas turbine engine 12 is shown in a simple cycle configuration of the plant 10 and includes an exhaust gas recirculation (EGR) system 14 that recirculates exhaust gas produced by the gas turbine engine 12.

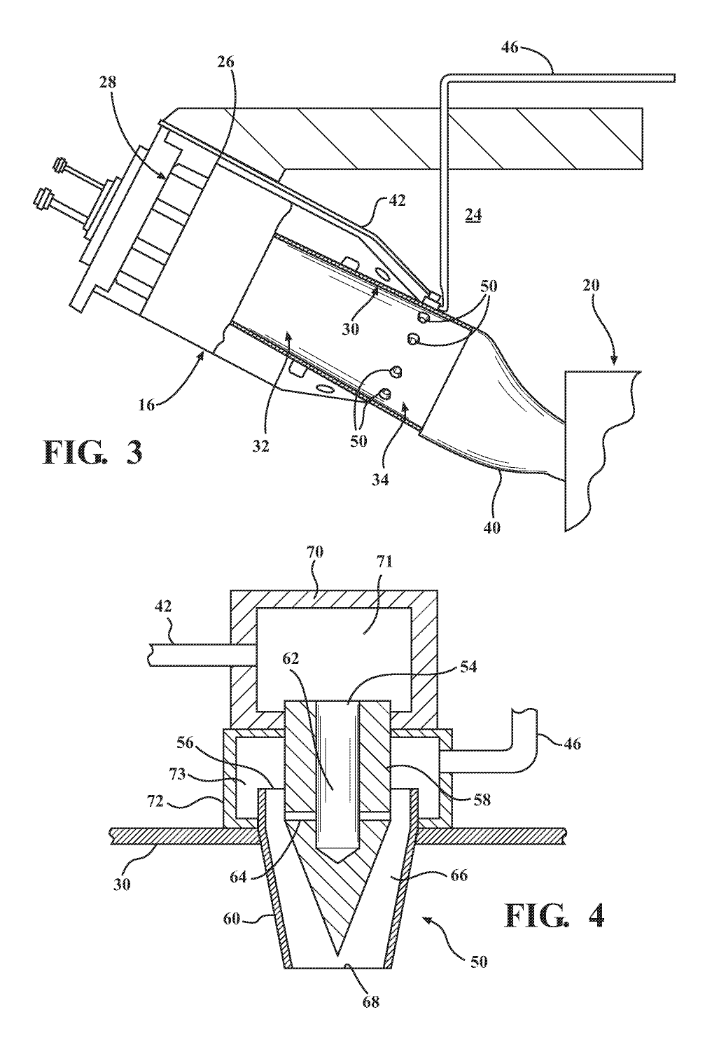

The gas turbine engine 12 includes a compressor 16, an axial stage combustor 18 and a turbine 20. The compressor 16 is configured to compress inlet air and provide compressed air to the combustor 18 through a compressed air passage, depicted by line 22. As can be seen in FIG. 3, the combustor 18 can be a can-annular combustor having a shell cavity 24 for receiving the compressed air from the compressor 16, and providing the compressed air (shell air) to a head end 26 of a combustor basket 28. The combustor 18 includes a combustor wall 30 defining a flow boundary for the hot gases passing through the combustor 18. The combustor wall 30 may be formed of one or more cylindrical wall segments, and surrounding and defining a first axial stage 32 of the combustor 18, forming a primary or first combustion zone, and a second axial stage 34 of the combustor 18 forming a secondary or second combustion zone, downstream from the first combustion zone 32.

Referring to FIG. 1, fuel is supplied from a fuel source 36, such as via a primary or first fuel line 38, to the combustor 18. Typical fuels that may be provided include oil, natural gas, syngas, hydrogen or combinations of natural gas, syngas and hydrogen. The shell air and fuel can be combined at the head end 26 of the basket 28 and ignited in the first axial stage 32 to form a hot working gas. The hot working gas passes from the first axial stage 32, through the second axial stage 34 and into a working gas conduit or transition 40 (FIG. 3) transferring the hot working gas to the turbine 20. A secondary or second fuel line 42 conveys fuel (secondary fuel) from the fuel source 36 to the combustor 18 where the fuel is injected into the second axial stage 34 to produce additional combustion products in a second axial stage of combustion in order to increase the TIT. The turbine 20 expands the hot working gas to extract work, rotating a shaft 44 to power the compressor 16 and/or a load, such as a generator 45.

In accordance with an aspect of the invention, the EGR system 14 includes an exhaust flow line 46 that extends from an exhaust exit 48 of the turbine 20 to an axial stage downstream of the first axial stage 32 of the combustor 18 and, more particularly, to the second axial stage 34 defining the second combustion zone. As is described further below, a portion of the exhaust flow may be extracted from the exhaust gas flow at a flow splitter 49 to be conveyed by the exhaust flow line 46 to the combustor 18. The exhaust gas conveyed by the EGR system 14 is mixed with the secondary fuel supplied by the second fuel line 42 and injected into the combustor 18 through a plurality of circumferentially spaced injection nozzles 50 (FIG. 3) extending through the wall 30 of the combustor 18. A heat exchanger 52 can be provided in the exhaust flow line 46 to cool the exhaust gas prior to mixing with the secondary fuel. In accordance with a further aspect of the invention, the exhaust gas is preferably cooled a minimal amount by the heat exchanger 52 as it is conveyed to the combustor 18 to thereby minimize the energy utilized for cooling the exhaust gas with an associated improvement in plant efficiency.

Referring to FIG. 1, an EGR compressor 53 is also provided in the exhaust flow line 46 to increase the pressure of the exhaust gas to be provided to the second axial stage 34 of the combustor 18. In order to provide the exhaust gas at sufficient pressure for injection into the combustor 18, the compressor 53 increases the pressure in the exhaust flow line 46 to a pressure that is 2 to 4 bar above the pressure of the shell air.

Referring to FIG. 4, an embodiment of an injection nozzle 50 is shown extending through the wall 30 of the combustor 18. The nozzle 50 has a pair of inlets that can include a first inlet 54 for receiving fuel supplied from the second fuel line 42, and a second inlet 56 for receiving exhaust gas received from the exhaust flow line 46. It should be noted that the fuel supplied from the second fuel supply 42 and the exhaust gas from the exhaust flow line 46 are the exclusive constituents of a mixture formed in the injector nozzles 50. In particular, the fuel and exhaust gas are mixed in the nozzle 50 without addition of an oxidant such as shell air.

The first inlet 54 can be formed in a central body 58 of the nozzle 50, and the second inlet 56 can be defined between the central body 58 and a concentric outer body 60. The first inlet 54 provides a flow of fuel to a central passage 62 of the central body 58, and radial ports 64 in the central body 58 permit the fuel to pass into an outer main flow passage 66 to mix with the exhaust flow prior to being injected into the second axial stage 34 from a nozzle outlet 68. Although a specific embodiment of the nozzle has been described, it should be understood other nozzle configurations that provide the same or similar operational characteristics may be provided.

The injection nozzles 50 can be associated with manifolds that extend circumferentially around the combustor 18 to supply the fuel and recirculated exhaust gas from the second fuel line 42 and the exhaust flow line 46. Specifically, a circumferentially extending fuel manifold 70 can receive the fuel flow from the second fuel line 42, and includes an interior passage 71 in fluid communication with the first inlet 54 of each injection nozzle 50. Similarly, a circumferentially extending exhaust gas manifold 72 can receive the exhaust flow from the exhaust flow line 46, and includes an interior passage 73 in fluid communication with the second inlet 56 of each injection nozzle 50. Alternatively, it may be understood that each of the nozzles 50 could be fed fuel and exhaust gas through individual lines supplied from the second fuel line 42 and the exhaust flow line 46 directly to the respective first and second inlets 54, 56.

In accordance with an aspect of the invention, the EGR system 14 is configured to supply recirculated exhaust gas to the combustor 18 to permit operation of the combustor at elevated firing temperatures of about 1700° C. without increasing NOx emissions above acceptable levels. In particular, the addition of recirculated exhaust gas to the second axial stage 34 lowers the stoichiometric flame temperature, permitting operation of the combustor 18 at higher flame temperatures without increasing NOx emissions above acceptable limits. An aspect of the present invention includes providing the entire mass flow of recirculated exhaust gas extracted from the turbine engine 12 to the second axial stage 34 of the combustor 18, which may be contrasted with prior systems that provide recirculated exhaust gas to upstream locations, such as the head end of the combustor or to a stage of the compressor. It is believed that the present configuration enables less exhaust gas to be provided than configurations that supply exhaust gas to the upstream locations while obtaining the same effect, i.e., decreasing or preventing an increase of NOx emissions with increasing TIT's.

For example, exhaust flow line 46 of the EGR system 14 can provide a mass flow of exhaust gas extracted from the exhaust exit 48 of the turbine engine 12 that is between 8% and 15% of the total mass flow of exhaust gas exiting the turbine 20, whereas a configuration providing recirculated exhaust gas to the head end of the combustor may require more than 30% of the total mass flow of the exiting exhaust gas to get an emissions benefit. Additionally, in configurations that recirculate exhaust gas to upstream locations, such as the inlet to the compressor or the head end of the combustor, it is typically necessary to apply a substantial amount of cooling in order to avoid a severe drop in compressor efficiency, and may require cooling of the exhaust gas to temperatures that are not substantially above 40° C.

The cooling provided by the heat exchanger 52 to the exhaust gas supplied via the exhaust flow line 46 is a partial cooling, wherein partially cooling the exhaust flow is defined as cooling of the exhaust gas to a temperature below the auto-ignition temperature for the fuel when the exhaust gas exits the EGR compressor 53 in order to avoid auto-ignition of the fuel when it is mixed with the exhaust gas. In accordance with aspects of the invention, the partially cooled exhaust gas is at an elevated temperature above a temperature that could be efficiently utilized if the exhaust gas were injected to the head end 26 of the combustor 18, i.e., substantially above 40° C. However, in contrast to configurations providing exhaust gas to upstream locations, an elevated temperature of the exhaust gas provided to the second axial stage 34 does not substantially affect the efficiency of the engine. Hence, it is an object of the present invention to provide exhaust gas to an axial stage of the combustor 18 at an elevated temperature, i.e., with reduced energy expended to cool the exhaust gas, in order to provide an exhaust gas diluent while minimizing or reducing any decrease in engine efficiency associated with cooling the exhaust gas. It is believed that the described turbine engine configuration and operation can allow higher TIT's while reducing energy losses associated with exhaust gas cooling.

It may be noted that providing the exhaust gas at a temperature below the auto-ignition temperature can also ensure against flashback in the fuel line 42. In addition, the fuel and exhaust gas can be conveyed to the nozzle inlets 54, 56 in separate lines or flow paths to maintain the fuel separated from the exhaust gas up to the mixing location adjacent to entry to the second axial stage 34.

Auto-ignition temperatures of gas turbine engine fuels may be in the range of 400° C. to 500° C. such that, in accordance with an aspect of the invention, the exhaust gas provided to the second axial stage 34 is preferably supplied at a temperature below 400° C. Further, in order to maintain the long term service life of the exhaust flow line 46, the exhaust gas should be cooled to a temperature within the operating limits of the material forming the exhaust flow line 46.

Exemplary temperatures for the exhaust gas provided to the axial stage of combustor 18 could be temperatures greater than 100° C., defined as a temperature substantially above 40° C., and in the simple cycle case would be elevated temperatures that are at least about 200° C. greater than the temperature of gases, e.g., shell air, provided to the head end 26 of the combustor 18 so as to substantially reduce the energy required for cooling the exhaust gas. In general, it may be understood that higher exhaust gas temperature entering the axial stage of the combustor 18, with an associated reduced cooling, up to a temperature below an auto-ignition temperature, e.g., below 400° C., will provide an improvement in the plant efficiency in accordance with the described aspects of the present invention.

Additionally, since the elevated temperature of the exhaust gas is below the auto-ignition temperature of the fuel, auto-ignition of the fuel/exhaust gas mixture is avoided in the nozzles 50. Although it is considered preferable to provide mixing of the fuel and exhaust gas in the nozzle 50 as it enters the axial stage of the combustor 18, it is within the scope of the invention to form a fuel/exhaust gas mixture at an upstream location of the supply line, such as upstream of a nozzle for injection of the mixture into the axial stage of the combustor 18.

Referring to FIG. 2, an alternative configuration for a power plant 10′ is illustrated. The power plant 10′ includes a gas turbine engine 12 to generate power and/or electricity from the production of a high temperature working gas during combustion. The gas turbine engine 12 is shown in a combined cycle configuration and includes an alternative exhaust gas recirculation (EGR) system 14′ that recirculates exhaust gas produced by the gas turbine engine 12.

In the alternative configuration of the exhaust gas recirculation (EGR) system 14′, a heat recovery steam generator (HRSG) 74 is located in the exhaust flow line 46 between an inlet to the EGR system 14′, defined at the turbine exhaust exit 48, and an outlet to the EGR system 14′ that is defined for example at the second nozzle inlet 56. The HRSG 74 receives the exhaust gas from the exhaust exit 48 of the turbine 20, and converts a substantial portion of the heat energy from the exhaust to steam for a steam cycle 76 in the combined cycle plant 10′. The steam cycle 76 can include one or more steam turbines (not shown) and may include an additional generator (not shown). The temperature of the exhaust gas at the exit 48 are typically in the range of about 600° C. to 700° C. and the temperature of the gases exiting the HRSG 74 are typically in the range of about 90° C. to 150° C.

A portion of the exhaust gas exiting the HRSG 74 may be split off at the flow splitter 49, e.g., between 8% and 15% of the total mass flow of exhaust gas, and the split off portion can be conveyed to the combustor 18 in the same manner as described above with reference to FIG. 1. The HRSG 74 can be the sole heat extraction component in the exhaust flow line 46, such that it will not be necessary to include the heat exchanger 52′, which is optionally depicted in dotted lines in FIG. 2. In the event that the heat exchanger 52′ is included, the energy required to cool the exhaust gas to a temperature below the auto-ignition temperature for compression and transfer through the exhaust flow line 46 would be less than that required for the embodiment of FIG. 1. Hence, the present invention could be implemented with a further improved efficiency in the embodiment of FIG. 2.

As with the embodiment of FIG. 1, the embodiment of FIG. 2 can provide exhaust gas as a diluent at an elevated temperature to the second axial stage 34 of the combustor 18. The elevated temperature of the exhaust gas diluent permits the plant 10′ to be operated with less energy used to cool the exhaust gas, providing an associated improved plant efficiency.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of operating an axial stage combustion system in a gas turbine engine having an axial stage combustor supplying hot working gases to a turbine, the method comprising:
providing a fuel supply line supplying a fuel to the combustor;
supplying compressed air to a head end of a combustor and mixing the compressed air with the fuel;
igniting the fuel and compressed air in a first axial stage of the combustor to form a hot working gas supplied to the turbine;
providing an exhaust gas recirculation (EGR) system extracting a portion of exhaust gas produced by the gas turbine engine to a second axial stage of the combustor, including:
conveying a mass flow of exhaust gas extracted from the gas turbine engine to a group of injector nozzles at the second axial stage of the combustor;
conveying a flow of fuel through a secondary fuel supply line to each of the injector nozzles, wherein the secondary fuel supply line extends to an inlet on each of the injector nozzles to isolate the fuel from the exhaust gas; and
mixing the fuel with the exhaust gas within the injector nozzles and injecting the mixture of fuel and exhaust gas into the second axial stage of the combustor.

2. The method of claim 1, wherein the fuel and exhaust gas are exclusive constituents of the mixture formed in the injector nozzle.

3. The method of claim 1, further comprising partially cooling the exhaust gas to a temperature below an auto-ignition temperature for the fuel as the exhaust gas is conveyed from the gas turbine engine to the injector nozzles.

4. The method of claim 3, further comprising, subsequent to the partial cooling, increasing the pressure of the exhaust gas to a pressure above a shell air pressure in the combustor while maintaining the temperature of the exhaust gas below the auto-ignition temperature for the fuel.

5. The method of claim 4, wherein the temperature of the exhaust gas provided to the second axial stage of the combustor is up to 200° C. greater than the temperature of gases provided to the head end of the combustor.

6. The method of claim 1, wherein the injector nozzles comprise a plurality of circumferentially spaced nozzles extending through a wall of the combustor defining a flow boundary in contact with the hot gases passing through the combustor.

7. The method of claim 1, wherein the entire mass flow of exhaust gas extracted from the gas turbine engine for the EGR system is conveyed to the second axial stage.

8. The method of claim 7, wherein the mass flow of exhaust gas extracted from the gas turbine engine is between 8% and 15% of the total mass flow of exhaust gas exiting the turbine.

9. The method of claim 1, further comprising conveying the exhaust gas through a heat recovery steam generator (HRSG) prior to the exhaust gas entering the second axial stage of the combustor, wherein the HRSG is the sole heat extraction component in a flow path for the exhaust gas from the gas turbine engine to the second axial stage of the combustor.

10. The method of claim 9, subsequent to passing through the HRSG, increasing the pressure of the exhaust gas to a pressure above a shell air pressure in the combustor while maintaining the temperature of the exhaust gas below an auto-ignition temperature for the fuel.

11. A method of operating an axial stage combustion system in a gas turbine engine having an axial stage combustor supplying hot working gases to a turbine, the method comprising:
providing a fuel supply line supplying a fuel to the combustor;
supplying compressed air to a head end of a combustor and mixing the compressed air with the fuel;
igniting the fuel and compressed air in a first axial stage of the combustor to form a hot working gas supplied to the turbine;
providing an exhaust gas recirculation (EGR) system extracting a portion of exhaust gas produced by the gas turbine engine to a second axial stage of the combustor, including:
conveying a mass flow of exhaust gas extracted from the gas turbine engine to the second axial stage of the combustor;
conveying a flow of fuel through a secondary fuel supply line to the second axial stage of the combustor;
mixing the fuel with the exhaust gas to provide a mixture of fuel and exhaust gas into the second axial stage of the combustor; and
conveying the exhaust gas through a heat recovery steam generator (HRSG) prior to the exhaust gas entering the second axial stage of the combustor, wherein the HRSG is the sole heat extraction component in a flow path for the exhaust gas from the gas turbine engine to the second axial stage of the combustor.

12. The method of claim 11, wherein the exhaust gas is partially cooled in the HRSG to a temperature below an auto-ignition temperature for the fuel.

13. The method of claim 12, further comprising, subsequent to passing through the HRSG, increasing the pressure of the exhaust gas to a pressure above a shell air pressure in the combustor while maintaining the temperature of the exhaust gas below the auto-ignition temperature for the fuel.

14. The method of claim 11, wherein the temperature of the exhaust gas provided to the second axial stage of the combustor is up to 200° C. greater than the temperature of gases provided to the head end of the combustor.

15. The method of claim 11, wherein the fuel and exhaust gas is provided to a plurality of circumferentially spaced nozzles extending through a wall of the combustor defining a flow boundary in contact with the hot gases passing through the combustor.

16. The method of claim 11, wherein the entire mass flow of exhaust gas extracted from the gas turbine engine for the EGR system is conveyed to the second axial stage and is between 8% and 15% of the total mass flow of exhaust gas exiting the turbine.

17. A power plant comprising:
a gas turbine engine having an axial stage combustor supplying hot working gases to a turbine;
a fuel supply supplying a fuel through a first supply line to the combustor;
the gas turbine engine having a compressor supplying compressed air to a head end of the combustor;
the combustor having a first axial stage where a mixture of the fuel and compressed air are ignited to form the hot working gas supplied to the turbine;
an exhaust gas recirculation (EGR) system having an inlet extracting a portion of exhaust gas produced by the gas turbine engine and an outlet providing exhaust gas as a diluent to a second axial stage of the combustor, the EGR system including:
an exhaust flow line conveying exhaust gas to the second axial stage of the combustor;
a secondary fuel supply line conveying fuel from the fuel supply to the second axial stage of the combustor;
a group of circumferentially spaced injector nozzles at the second axial stage of the combustor;
each of the injector nozzles having a pair of inlets including a separate inlet for receiving a flow of exhaust gas from the exhaust flow line and a separate inlet for receiving a flow of fuel from the secondary fuel flow line, and each injector nozzle mixing the exhaust gas with the fuel and injecting the mixture of exhaust gas and fuel into the second axial stage of the combustor.

18. The power plant of claim 17, wherein the entire portion of exhaust gas extracted from the gas turbine engine for the EGR system is conveyed to the second axial stage and is between 8% and 15% of the total mass flow of exhaust gas exiting the turbine.

19. The power plant of claim 17, further comprising a heat recovery steam generator (HRSG) located in the exhaust flow line between the inlet and the outlet of the EGR system, wherein the HRSG is the sole heat extraction component in the exhaust flow path from the gas turbine engine to the second axial stage of the combustor.
